(19) United States
(12) Patent Application Publication
(10) Pub. No.: US 2026/0230022 A1
(43) Pub. Date: Aug. 6, 2026

(54) MOTOR CONTROL DEVICE

(71) Applicant: FANUC CORPORATION, Minamitsuru-gun, Yamanashi (JP)

(72) Inventors: Ryou MORIHASHI, Yamanashi (JP); Shougo SHINODA, Yamanashi (JP)

(21) Appl. No.: 19/160,208

(22) PCT Filed: Apr. 14, 2023
(86) PCT No.: PCT/JP2023/015128

§ 371 Date: Aug. 27, 2025

(51) Int. Cl. H02P 23/04

(52) U.S. Cl. CPC H02P 23/04; H02P 2205/05; H02P 2205/07

(57) ABSTRACT

A motor control device includes a torque command creation unit which creates a torque command for specifying a drive torque of the motor in accordance with a speed command, a filter unit which decreases the value of a set frequency range of the speed command, an operation command creation unit which creates an operation command, and a measurement command creation unit which creates measurement commands that are each the speed command having a prescribed waveform to adjust the filter unit. The motor control device also includes a response characteristic calculation unit which calculates a frequency response characteristic of a signal downstream of the torque command creation unit and a filter setting unit which uses a resonance frequency corresponding to the frequency response characteristic with respect to at least two of the measurement commands to determine the frequency width of the set frequency range of the filter unit.

### TECHNICAL FIELD

The present invention relates to a motor control device.

### BACKGROUND ART

Such a technique has been known in which a filter for reducing gain near a resonance frequency of a control loop is provided in a motor control device to suppress a resonance peak and to smooth a frequency response characteristic. Furthermore, it has also been proposed that a frequency response characteristic of a control loop is measured to adjust a filter width in accordance with the frequency response characteristic (for example, see Patent Document 1).

### CITATION LIST

### Patent Document

Patent Document 1: Japanese Unexamined Patent Application, Publication No. 2007-306753

### DISCLOSURE OF THE INVENTION

### Problems to be Solved by the Invention

Although, in an ideal model, a frequency response characteristic of a control loop does not change, a frequency response characteristic of a control loop in an actual motor drive system may change in accordance with an operation situation. Therefore, in motor drive systems, there is a need for a technology that makes it possible to more appropriately suppress resonance peaks.

### Means for Solving the Problems

A motor control device according to an aspect of the present disclosure includes: a torque command creation unit that receives an inputted speed command for specifying a speed of a motor and that creates a torque command for specifying drive torque of the motor in accordance with the speed command; a filter unit that decreases a value within a set frequency range of the speed command or the torque command; an operation command creation unit that creates an operation command including the speed command for operating the motor; a measurement command creation unit that creates a plurality of measurement commands including the speed command or the torque command having a predetermined waveform for adjusting a set value of the filter unit; a response characteristic calculation unit that calculates a frequency response characteristic of a signal downstream of the torque command creation unit with respect to the measurement commands; and a filter setting unit that uses a corresponding resonance frequency of the frequency response characteristic with respect to at least two of the measurement commands to determine a frequency width of the set frequency range of the filter unit.

### BRIEF DESCRIPTION OF THE DRAWINGS

FIG. 1 is a block diagram illustrating a configuration of a motor control device according to an embodiment of the present disclosure;

FIG. 2 is a graph exemplifying changes due to a difference in sweeping direction for a measurement command for a frequency response characteristic in the motor control device illustrated in FIG. 1; and

FIG. 3 is a flowchart illustrating a procedure of determining a set value of a filter unit in the motor control device illustrated in FIG. 1.

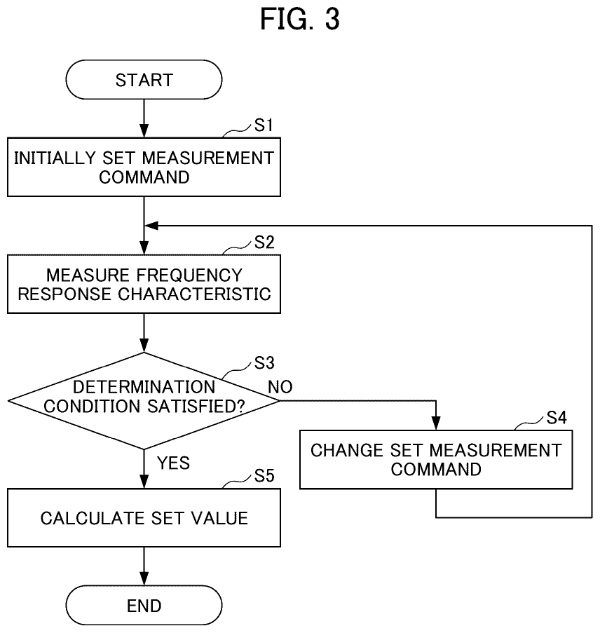

### PREFERRED MODE FOR CARRYING OUT THE INVENTION

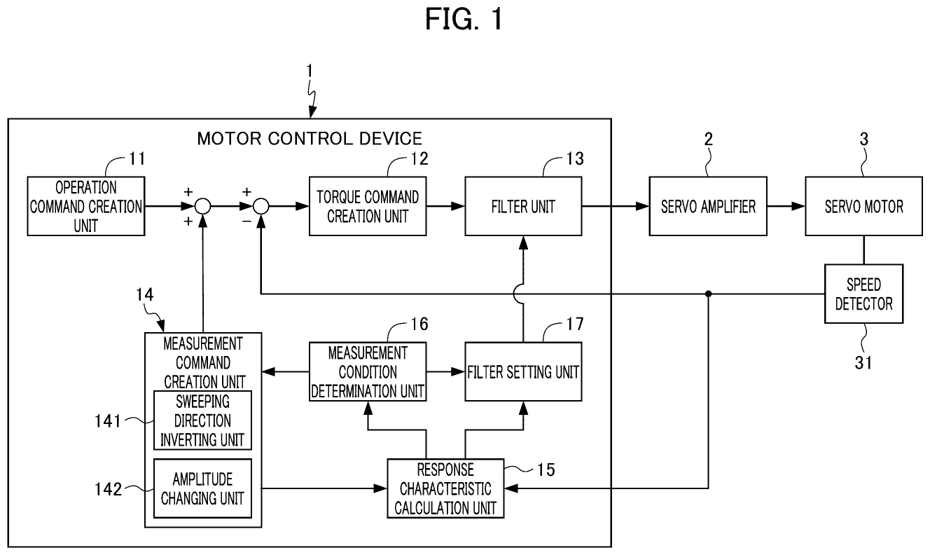

An embodiment of the present disclosure will now be described herein with reference to the accompanying drawings. FIG. 1 is a block diagram illustrating a configuration of a motor control device 1 according to the embodiment of the present disclosure.

The motor control device 1 controls a motor 3 via an amplifier 2. That is, the motor control device 1 inputs, to the amplifier 2, a torque command for specifying torque necessary for allowing the motor 3 to operate at a target speed at that time. The motor control device 1 is configured to perform feedback control for checking a detection value of a speed detector 31 that detects a speed of the motor 3 to optimize a torque command.

The motor control device 1 includes an operation command creation unit 11, a torque command creation unit 12, a filter unit 13, a measurement command creation unit 14, a response characteristic calculation unit 15, a measurement condition determination unit 16, and a filter setting unit 17. The motor control device 1 may be achieved as one or a plurality of computer devices each including a memory, a processor, and an input-and-output interface, for example, is or are caused to execute an appropriate control program. The components of the motor control device 1 are classified according to functions of the motor control device 1, and may not be clearly divided from each other in physical configuration and program configuration.

The operation command creation unit 11 creates an operation command including a speed command for specifying the speed of the motor 3 for operating the motor 3. The operation command creation unit 11 reads data and an operation program described in a language such as G code, for example, which identify operation required for the motor 3, that is, a waveform of a change in the speed of the motor 3, and continuously outputs a value indicating the rotation speed of the motor 3 when the motor 3 is operated in accordance with the operation program. As an example, the operation command creation unit 11 may be configured to generate a position command for specifying a rotation position of the motor 3, and create an operation command from the position command.

The torque command creation unit 12 creates a torque command for specifying drive torque of the motor 3 in accordance with a speed command to be inputted. That is, the torque command creation unit 12 calculates a magnitude of the drive torque required for the motor 3 to actually rotate at the speed that the speed command specifies.

The filter unit 13 receives a torque command inputted from the torque command creation unit 12, and decreases a value within a set frequency range of a torque command to be inputted. As a specific example, the filter unit 13 may be configured to perform Fourier transform on the inputted torque command, multiply the value within the set frequency range by a relatively small gain, and then perform inverse Fourier transform to create a speed command with a reduced set frequency value.

The measurement command creation unit 14 creates a plurality of measurement commands each having a predetermined waveform for adjusting a set value of the filter unit 13. A measurement command that the measurement command creation unit 14 creates, which includes a speed command to be inputted to the torque command creation unit 12 in the present embodiment, may include a torque command to be inputted to the amplifier 2. To allow the response characteristic calculation unit 15 to easily calculate a frequency response characteristic, a measurement command that the measurement command creation unit 14 creates may preferably be one that has a waveform that periodically changes in value and that is to be swept to change in frequency. A measurement command may have, for example, a triangular wave, a rectangular wave, or a saw-tooth wave, and may preferably have a sine wave to reduce a load related to an arithmetic operation of the response characteristic calculation unit 15. Furthermore, a measurement command may lead to, for example, a change having a ramp shape, an impulse shape, or an M-sequence signal shape.

The measurement command creation unit 14 according to the present embodiment includes a sweeping direction inverting unit 141 that inverts a sweeping direction for a measurement command and an amplitude changing unit 142 that changes the amplitude of a measurement command. Thereby, the measurement command creation unit 14 is able to create three or more measurement commands. The measurement command creation unit 14 may be configured to sequentially create different measurement commands in a predetermined order, or may be configured to change an aspect of the measurement command in response to a result of determination of the measurement condition determination unit 16. In a changed aspect of a measurement command in the measurement command creation unit 14, selection of the sweeping direction by the sweeping direction inverting unit 141 and changing of the amplitude by the amplitude changing unit 142 may be combined in a desired order.

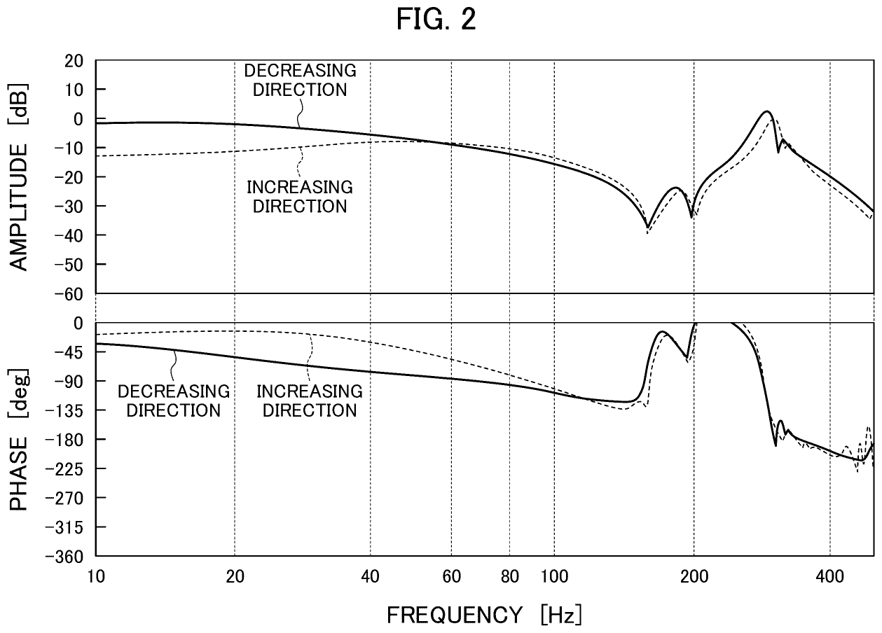

The sweeping direction inverting unit 141 sets whether a measurement command is swept in a decreasing direction in which a frequency gradually decreases from a high frequency or swept in an increasing direction in which the frequency gradually increases from a low frequency. Between a case where a measurement command is swept in the decreasing direction of the frequency and a case where a measurement command is swept in the increasing direction of the frequency, a gap may possibly occur in resonance frequency to be calculated, as exemplified in FIG. 2. Generally, a resonance frequency in a case of sweeping in the decreasing direction of the frequency may have a smaller value than a value of a resonance frequency in a case of sweeping in the increasing direction of the frequency.

The amplitude changing unit 142 sets the amplitude of a measurement command. Changing the amplitude of a measurement command may also change the profile of a frequency response characteristic, causing a resonance frequency to move. As an example, the amplitude changing unit 142 may be configured to select one amplitude from among a predetermined plurality of amplitudes, may be configured to change the amplitude by multiplying the current amplitude by a predetermined ratio, or may be configured to change the amplitude by adding the current amplitude with a predetermined error,

The response characteristic calculation unit 15 calculates a frequency response characteristic with respect to a measurement command of a signal downstream of the torque command creation unit 12. Note that a “signal downstream of the torque command creation unit 12” means a signal to be outputted from the torque command creation unit 12 and a component downstream of the torque command creation unit 12, and should not be determined from a position at which the signal is inputted (returned). Furthermore, even when there is a component (for example, an amplifier or a filter) that processes a signal before the signal is returned, the signal to be returned is regarded as a “signal downstream of the torque command creation unit 12” based on a flow of the signal to a position at which the signal is outputted. In the exemplified embodiment, the response characteristic calculation unit 15 calculates a frequency response characteristic of the motor 3 with respect to a measurement command based on a feedback value from the motor 3 with respect to the measurement command, that is, a detection value of the speed detector 31. The frequency response characteristic may include a gain with respect to a measurement command of a target signal or a phase difference in the speed of the motor 3 with respect to the measurement command or both the gain and the phase difference. Using a frequency response characteristic including both a gain and a phase difference makes it possible to more appropriately set, for example, a frequency width (a filter width) of a set frequency range for decreasing a speed command of the filter unit 13.

The measurement condition determination unit 16 determines whether or not a calculation of a frequency response characteristic based on a further different measurement command is necessary from a frequency response characteristic with respect to the plurality of measurement commands having already been measured. When a relationship between a newly measured frequency response characteristic and a previously measured frequency response characteristic does not satisfy a predetermined determination condition, the measurement condition determination unit 16 may be configured to cause the measurement command creation unit 14 to create a measurement command under a different condition. As an example, the measurement condition determination unit 16 may be configured to cause the amplitude changing unit 142 to gradually increase or decrease the amplitude of a measurement command until a frequency response characteristic satisfies the predetermined determination condition. Furthermore, the measurement condition determination unit 16 may be configured to allow a user to set a determination condition such as a threshold value.

Specifically, when there is no movement in resonance frequency from the frequency response characteristic related to a measurement command at the previous amplitude even when the amplitude of the measurement command is increased or decreased, that is, when a difference in resonance frequency is equal to or below a set threshold value, the measurement condition determination unit 16 may be configured to request the filter setting unit 17 to determine a set value of the filter unit 13 without newly measuring a frequency response characteristic. The measurement condition determination unit 16 may determine whether or not it is necessary to newly measure a frequency response characteristic based on, for example, a gain of a frequency response or a ratio between an input and an output of a time response. Furthermore, when it is clear that a partial frequency response characteristic acquired before the measurement command creation unit 14 completes sweeping of a measurement command does not satisfy the determination condition, the measurement condition determination unit 16 may request the measurement command creation unit 14 to interrupt the sweeping of the measurement command and to start outputting of a measurement command under a different condition.

The filter setting unit 17 uses a corresponding resonance frequency of a frequency response characteristic with respect to at least two measurement commands to determine a frequency width of a set frequency range of the filter unit 13. When the measurement condition determination unit 16 has measured a frequency response characteristic with respect to three or more measurement commands, it is preferable to determine a frequency width based on a maximum value and a minimum value of corresponding resonance frequencies related to these measurement commands. That is, the filter setting unit 17 may be configured to take into account a maximum frequency and a minimum frequency at an identical resonance point that has been moved due to a change in measurement command to calculate a filter width.

The filter setting unit 17 is configured to store necessary information when the response characteristic calculation unit 15 has calculated a frequency response characteristic. When a frequency response characteristic with respect to three or more measurement commands is to be calculated, it may be configured to successively delete information that is not used for calculation of a set value of the filter unit 13, that is, to overwrite old information with new information and store the new information. As an example, it may be configured to store only a minimum value and a maximum value for resonance frequencies, and overwrite a value of the minimum value when a resonance frequency of a newly acquired frequency response characteristic is smaller than the stored minimum value and overwrite a value of the maximum value when the resonance frequency of the newly acquire frequency response characteristic is greater than the stored maximum value.

As a specific example, when a minimum value of a resonance frequency is represented by f1, a filter width set with a known method from a profile of a frequency response characteristic having the resonance frequency is represented by x1, a maximum value of the resonance frequency is represented by f2, and a filter width based on the profile of the frequency response characteristic is represented by x2, a central frequency of the filter is set between f1 and f2, and a filter width is set to a frequency width including a range of f1+/−x1 and a range of f2+/−x2. Specifically, when f1 is set as the central frequency of the filter, it is possible to set a filter width W to either 2* (f2−f1+x2/2) or x1, whichever is larger. Furthermore, when an average frequency of f1+f2 [(f1+f2)/2] is set as the central frequency of the filter, it is possible that the filter width W=2*((f2−f1) /2+x2/2) when x2>x1 and the filter width W=2* ((f2−f1) /2+x1/2) when x1>x2.

FIG. 2 is a flowchart illustrating a procedure of determining a set value of the filter unit 13 in the motor control device 1. The procedure of determining a set value of the filter unit 13 includes a process of initially setting a measurement command (Step S1), a process of measuring a frequency response characteristic (Step S2), a process of. checking whether or not a determination condition is satisfied (Step 83), a process of changing the set measurement command (Step S4), and a process of calculating a set value (Step S5). In this procedure, processing of changing the amplitude of a measurement command, for example, at Step S4 and measuring a frequency response characteristic with respect to the measurement command at Step S2 is repeated until the determination condition is satisfied at Step S3. When the determination condition is satisfied at Step S3, a filter width, for example, is set based on the frequency response characteristic that has been acquired at Step S5.

As described above, the motor control device 1, which includes the measurement command creation unit 14 that creates a plurality of measurement commands and the filter setting unit 17 that takes into account a corresponding resonance frequency in the plurality of measurement commands to determine a filter width of the filter unit 13, makes it possible to effectively lower an output in peak due to resonance even when an input has caused a resonance frequency to move. That is, the motor control device 1, which makes it possible to relatively flatten the profile of an output characteristic of the motor 3, makes it possible to achieve more accurate control of the motor 3.

Regarding the embodiment described above and modification examples, notes described below are further disclosed.

### Note 1

A motor control device (1) includes: a torque command creation unit (12) that receives an inputted speed command for specifying a speed of a motor (3) and that creates a torque command for specifying drive torque of the motor (3) in accordance with the speed command; a filter unit (13) that decreases a value within a set frequency range of the speed command or the torque command; an operation command creation unit (11) that creates an operation command including the speed command for operating the motor (3); a measurement command creation unit (14) that creates a plurality of measurement commands including the speed command or the torque command having a predetermined waveform for adjusting a set value of the filter unit (13) ; a response characteristic calculation unit (15) that calculates a frequency response characteristic of a signal downstream of the torque command creation unit (12) with respect to the measurement commands; and a filter setting unit (17) that uses a corresponding resonance frequency of the frequency response characteristic with respect to at least two of the measurement commands to determine a frequency width of the set frequency range of the filter unit (13).

### Note 2

The motor control device (1) according to Note 1, in which the measurement commands may be ones that each periodically change in value and that are to be swept to change in frequency, and the measurement command creation unit (14) may include a sweeping direction inverting unit (141) that inverts a sweeping direction for the measurement commands.

### Note 3

The motor control device (1) according to Note 1 or 2, in which the measurement command creation unit (14) may include an amplitude changing unit (142) that changes an amplitude of each of the measurement commands.

### Note 4

The motor control device (1) according to any one of Notes 1 to 3, in which the filter setting unit (17) may determine the frequency width based on a maximum value and a minimum value among corresponding resonance frequencies related to the plurality of measurement commands.

### Note 5

The motor control device (1) according to any one of Notes 1 to 4 may further include a measurement condition determination unit (16) that determines whether or not another calculation of a frequency response characteristic based on a further different measurement command is necessary from the frequency response characteristic with respect to the plurality of measurement commands.

Although the present disclosure has been described above in detail, the present disclosure is not limited to the embodiment described above. It is possible to variously make additions, replacements, modifications, and partial deletions, for example, in the embodiment without departing from the gist of the present disclosure or without departing from the scope of the present disclosure, which is derived from the contents described in Claims and their equivalents. Furthermore, it is possible to implement the embodiment in a combined manner. For example, in the embodiment described above, the order of operations and the order of steps in the processing are indicated as mere examples, and the present disclosure is not limited to the embodiment. Furthermore, the same applies to cases where a numerical value or a numerical expression is used to describe the embodiment described above.

As an example, in the motor control device according to the present disclosure, for example, the measurement command creation unit may be configured to be able to output only two types of measurement commands that differ from each other in only sweeping direction. In this case, the measurement condition determination unit becomes unnecessary, and, when frequency response characteristics related to the two types of the measurement commands are calculated, the filter setting unit may be configured to immediately use their resonance frequencies to determine a filter width. Furthermore, in the motor control device according to the present disclosure, the measurement command creation unit may include the amplitude changing unit only. Furthermore, although, in the embodiment described above, filtering of a torque command is performed, filtering of a speed command may be performed. Furthermore, although, in the embodiment described above, feedback of a speed signal is provided from the motor, feedback of a position signal or torque signal, for example, may be provided. Furthermore, a position at which a feedback signal is to be inputted may differ depending on a signal provided as feedback.

### EXPLANATION OF REFERENCE NUMERALS

1 Motor control device
11 Operation command creation unit
12 Torque command creation unit
13 Filter unit
14 Measurement command creation unit
141 Sweeping direction inverting unit
142 Amplitude changing unit
15 Response characteristic calculation unit
16 Measurement condition determination unit
17 Filter setting unit
2 Amplifier
3 Motor
31 Speed detector

1. A motor control device comprising:
a torque command creation unit that receives an inputted speed command for specifying a speed of a motor and that creates a torque command for specifying drive torque of the motor in accordance with the speed command;
a filter unit that decreases a value within a set frequency range of the speed command or the torque command;
an operation command creation unit that creates an operation command including the speed command for operating the motor;
a measurement command creation unit that creates a plurality of measurement commands including the speed command or the torque command having a predetermined waveform for adjusting a set value of the filter unit;
a response characteristic calculation unit that calculates a frequency response characteristic of a signal downstream of the torque command creation unit with respect to the measurement commands; and
a filter setting unit that uses a corresponding resonance frequency of the frequency response characteristic with respect to at least two of the measurement commands to determine a frequency width of the set frequency range of the filter unit.

2. The motor control device according to claim 1, wherein the measurement commands are ones that each periodically change in value and that are to be swept to change in frequency, and
the measurement command creation unit includes a sweeping direction inverting unit that inverts a sweeping direction for the measurement commands.

3. The motor control device according to claim 1, wherein the measurement command creation unit includes an amplitude changing unit that changes an amplitude of each of the measurement commands.

4. The motor control device according to claim 1, wherein the filter setting unit determines the frequency width based on a maximum value and a minimum value among corresponding resonance frequencies related to the plurality of measurement commands.

5. The motor control device according to claim 4, further comprising a measurement condition determination unit that determines whether or not another calculation of a frequency response characteristic based on a further different measurement command is necessary from the frequency response characteristic with respect to the plurality of measurement commands.
